(19) United States
(12) Patent Application Publication
(10) Pub. No.: US 2026/0351102 A1
(43) Pub. Date: Nov. 5, 2026

(54) INFORMATION PROCESSING DEVICE, INFORMATION PROCESSING METHOD, INFORMATION PROCESSING SYSTEM, BASE STATION, AND TERMINAL

(71) Applicant: SONY SEMICONDUCTOR SOLUTIONS CORPORATION, KANAGAWA (JP)

(72) Inventor: MASAYA TAKANO, KANAGAWA (JP)

(21) Appl. No.: 18/997,524

(22) PCT Filed: Jul. 21, 2023
(86) PCT No.: PCT/JP2023/026708

§ 371 Date: Jan. 22, 2025

(30) Foreign Application Priority Data
Aug. 12, 2022 (JP) 2022-128954

(51) Int. Cl. G08B 13/196; G01S 5/14; G06T 11/60; G06V 20/52; G08B 13/181; H04N 23/90

(52) U.S. Cl. CPC G08B 13/19691; G01S 5/14; G06T 11/60; G06V 20/52; G08B 13/181; H04N 23/90

(57) ABSTRACT

An information processing device, an information processing method, an information processing system, a base station, and a terminal that enable easier acquisition of image information regarding a missing object are to be provided. An information processing device includes: a positioning information processing unit that generates position coordinates in chronological order, on the basis of distance measured by radio distance measurement from a plurality of sets of coordinates to a terminal attached to an article; and a first control unit that causes a display unit to display an image on the basis of the time of the radio distance measurement, the image having an imaging range including a position in a space, the position corresponding to at least one set of the chronological position coordinates, the image corresponding to the time at which the position in the space has been measured by radio distance measurement.

### TECHNICAL FIELD

The present disclosure relates to an information processing device, a terminal, a base station, and an information processing system.

### BACKGROUND ART

One of the main roles of a surveillance camera in a store is to monitor customers who illegally take away products. Therefore, the surveillance camera is installed at a place from which the passage between shelves can be seen. For example, there is a case where a person crouching in the screen of a surveillance camera is putting an article 500 (DVD case size: 136×14×190 mm) taken away from the shelf into a bag (see FIG. 18).

### CITATION LIST

### Patent Document

Patent Document 1: Japanese Patent Application No. 2012-543148

### SUMMARY OF THE INVENTION

### Problems to be Solved by the Invention

However, in a case where the store side notices the theft and searches for evidence from a camera image, the store side searches for the article and the bag that are only shown as small objects on the screen. Further, there may be a case where another person or another object appears between the camera and the site of the theft, and the site of the theft is not visible from the camera. In that case, even if camera images are searched, there are no captured scenes showing the object being put into the bag. In a case where a situation in which an object has been put into a bag occurs, “what is missing” is recognized, but it is necessary to search for the “time” and “site” at which it occurred, from images captured by all surveillance cameras.

Therefore, the present disclosure provides an information processing device, an information processing method, an information processing system, a base station, and a terminal that enable easier acquisition of image information regarding a missing object.

### Solutions to Problems

To solve the above problems, the present disclosure provides an information processing device that includes:
a positioning information processing unit that generates position coordinates in chronological order, on the basis of distance measured by radio distance measurement from a plurality of sets of coordinates to a terminal attached to an article; and
a first control unit that causes a display unit to display an image on the basis of the time of the radio distance measurement, the image having an imaging range including a position in a space, the position corresponding to at least one set of the chronological position coordinates, the image corresponding to the time at which the position in the space has been measured by radio distance measurement.

In a case where the position coordinates are located within a predetermined region, the first control unit may cause the display unit to display the image.

The radio distance measurement may be performed by a distance measurement method using phase characteristics of frequency through wireless communication between a plurality of base stations and the terminal.

In a case where the position coordinates are located within the predetermined region, the first control unit may issue warning information.

The display unit may display the image captured at the point of time when the terminal started moving.

A storage unit may be further included, and the positioning information processing unit may generate the position coordinates associated with the time of the radio distance measurement.

A map image generation unit that superimposes a chronological change in the position coordinates as trajectory information on a map image may be further included.

The display unit may display, side by side, the map image on which the trajectory information is superimposed, and the image corresponding to the time of the radio distance measurement of the position coordinates included in the trajectory information.

A recognition processing unit that recognizes the region of the article from the image may be further included.

The recognition processing unit may superimpose a first mark indicating the region in the image.

The recognition processing unit may superimpose a second mark indicating a portion corresponding to the position coordinates in the image.

The first control unit may cause the recognition processing unit to start a recognition process in a case where the position coordinates are located within a predetermined region.

A reading unit that reads first identification information about the article may be further included, and
the recognition processing unit may recognize the region through a recognition process corresponding to the first identification information.

The reading unit may be capable of reading second identification information about the terminal, and store the second identification information associated with the first identification information into the storage unit.

In a case where the first identification information or the second identification information is read, the first control unit may stop generation of the position coordinates of the article, and stop operation of the terminal.

The first control unit may select a base station that measures distance to the terminal through wireless communication with the terminal on the basis of the position coordinates, select an image captured from a plurality of sets of predetermined coordinates on the basis of the position coordinates, and cause the display unit to display the image.

To solve the above problems, the present disclosure provides an information processing method that includes:
a positioning information processing step of generating position coordinates in chronological order, on the basis of distance measured by radio distance measurement from a plurality of sets of coordinates to a terminal attached to an article; and
a first control step of causing a display unit to display an image on the basis of the time of the radio distance measurement, the image having an imaging range including a position in a space, the position corresponding to at least one set of the chronological position coordinates, the image corresponding to the time at which the position in the space has been measured by radio distance measurement.

To solve the above problems, the present disclosure provides an information processing system that includes:
a plurality of base stations that is used to measure distance to a terminal attached to an article by a distance measurement method using phase characteristics of frequency through wireless communication with the terminal;
an imaging unit that is included in the base station or a camera, and captures an image of the terminal attached to the article while putting the terminal in an imaging range; and
an information processing device, in which
the information processing device includes:
a positioning information processing unit that generates position coordinates in chronological order, on the basis of distance measured by radio distance measurement from coordinates of the plurality of base stations to the terminal; and
in the image captured by the imaging unit,
a first control unit that causes a display unit to display an image on the basis of the time of the radio distance measurement, the image having an imaging range including a position in a space, the position corresponding to at least one set of the chronological position coordinates, the image corresponding to the time at which the position in the space has been measured by radio distance measurement.

To solve the above problems, the present disclosure provides an imaging device that includes:
a distance measurement unit that is used to generate position coordinates of a terminal attached to an article in chronological order, and performs radio distance measurement to measure distance to the terminal;
a wireless communication unit that wirelessly communicates with the terminal; and
an imaging unit that includes an imaging optical system having a specified imaging range and an imaging element, and captures an image with which the position coordinates can be associated in a captured image.

To solve the above problems, the present disclosure provides a terminal that is attached to an article, the terminal including:
a distance measurement unit that is used to generate position coordinates of the terminal in chronological order, and performs radio distance measurement with a predetermined base station to measure distance to the terminal; and
a wireless communication unit that wirelessly communicates with the predetermined base station.

### BRIEF DESCRIPTION OF DRAWINGS

FIG. 1 is a diagram illustrating an example configuration of an information processing system 1 according to a first embodiment of the present technology.

FIG. 2 is a plan view of the inside of a store to be monitored.

FIG. 3 is a block diagram illustrating an example configuration of a base station 10.

FIG. 4 is a diagram for explaining the principles of measuring distance by a phase-based distance measurement method.

FIG. 5 is a diagram illustrating an example of a graph for calculating a group delay τ.

FIG. 6 is a block diagram illustrating an example configuration of a terminal 20.

FIG. 7 is a block diagram illustrating an example configuration of an information processing device 30.

FIG. 8 is a block diagram illustrating an example configuration of an image processing unit 306.

FIG. 9 is a plan view illustrating a case where a terminal 20A has moved.

FIG. 10 is a sequence diagram illustrating an operation of each component in the system in a case where the terminal 20A has moved.

FIG. 11 is a plan view illustrating a case where the terminal 20A has moved, and a monitoring end process is performed at the counter.

FIG. 12 is a sequence diagram at the time of a monitoring end process.

FIG. 13 is a plan view illustrating a case where a terminal has entered an event occurrence region without having been subjected to a monitoring end process.

FIG. 14 is a sequence diagram illustrating a case of entering an event occurrence region.

FIG. 15 is a diagram illustrating an example configuration of an information processing system according to a second embodiment of the present technology.

FIG. 16 is a block diagram illustrating an example configuration of a camera.

FIG. 17 is a plan view of the inside of a store to be monitored.

FIG. 18 is a view of a scene in which a person crouching in the screen of a camera is putting an article of a DVD case size into a bag.

### MODE FOR CARRYING OUT THE INVENTION

In the description below, embodiments of an information processing device, an information processing method, an information processing system, a base station, and a terminal will be explained with reference to the drawings. Although the principal components of an information processing device, an information processing method, an information processing system, a base station, and a terminal will be mainly described below, the information processing device, the information processing method, the information processing system, the base station, and the terminal may include components and functions that are not illustrated or described. The following description does not exclude components and functions that are not illustrated or described.

### First Embodiment

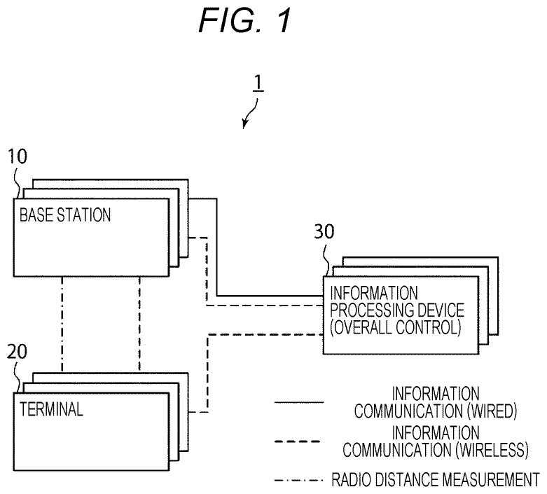

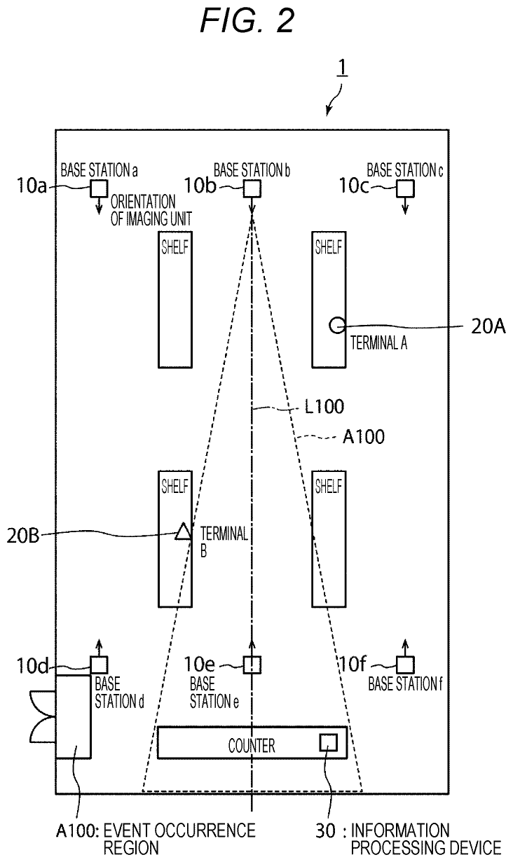

FIG. 1 is a diagram illustrating an example configuration of an information processing system 1 according to a first embodiment of the present technology. As illustrated in FIG. 1, the information processing system 1 includes a plurality of base stations 10, a terminal 20, and an information processing device 30. There may be a plurality of terminals 20 and a plurality of information processing devices 30. A base station 10 can capture an image of the monitoring range, and measure a distance to a terminal 20 with radio waves through communication with the terminal 20. The terminals 20 are formed tags, for example, and are secured to articles such as DVDs. A terminal 20 can measure a distance to a base station 10 through communication with the base station 10. An information processing device 30 can control base stations 10 and terminals 20, and monitors the position of the terminals 20. Specific configurations of the base stations 10, the terminals 20, and the information processing devices 30 will be described later.
FIG. 2 is an example of a plan view of the inside of a store to be monitored. Articles are on shelves in the store. In FIG. 2, a plurality of base stations 10a, b, c, d, e, and f, a plurality of terminals 20A and B, and an information processing device 30 are arranged. The information processing system 1 is a system that monitors the positions of the plurality of terminals 20A and B secured to articles, for example, and can issue an alarm or the like and present a related image in a case where any of the terminals 20A and B enters an event occurrence region A100.

The plurality of base stations 10a, b, c, d, e, and f are installed in a form in which the imaging units are oriented in directions in which the passages between the shelves can be monitored, for example. The information processing device 30 is installed on a counter. The terminal 20A and the terminal 20B are attached to articles that need to be managed. When the articles are moved, the attached terminals move with the articles. Note that each of the base stations 10a, b, c, d, e, and f can transmit presence information signals indicating its own presence at regular intervals, to cope with the terminals 20A and B searching for a to-be-used base station. Further, the orientation and the imaging range A100 of the optical axis L100 of the imaging optical system of each of the base stations 10a, b, c, d, e, and f are defined in the world coordinate system. Likewise, the ranges of radio distance measurement by the base stations 10a, b, c, d, e, and f are defined in the world coordinate system. Note that, in the present embodiment, coordinates are described in the world coordinate system in some cases, but the present invention is not limited to this. For example, the lower left of the in-store plan view, for example, may be expressed in a local coordinate system such as coordinates (x, y, z)=(0, 0, 0). With this arrangement, even in a case where the plurality of terminals 20A and B does not have a position measurement unit 204, for example, processing can be performed with the local coordinate system of the information processing system 1.

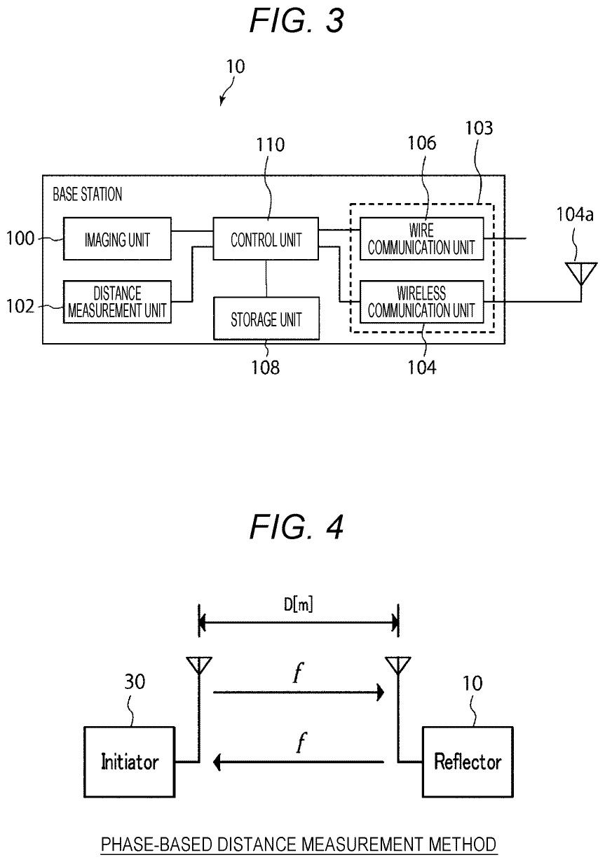

FIG. 3 is a block diagram illustrating an example configuration of a base station 10. As illustrated in FIG. 3, the base station 10 includes an imaging unit 100, a distance measurement unit 102, a communication unit 103, a storage unit 108, and a control unit 110. This base station 10 includes a central processing unit (CPU), for example, and forms the respective components by executing various programs stored in the storage unit 108. Further, the communication unit 103 includes a wireless communication unit 104 and a wire communication unit 106.

The imaging unit 100 includes an imaging optical system and an imaging element. This imaging unit 100 captures an image of the monitoring region with the imaging element via the imaging optical system, and stores the image into the storage unit 108. This imaging unit 100 captures an image of the environment in which the base station 10 is present. Note that the base station 10 may include a plurality of imaging units 100. Alternatively, the base station 10 may not include the imaging unit 100 in a case where the monitoring region can be sufficiently imaged by another base station in the information processing system 1. Further, the imaging unit 100 associates images of the monitoring region with time, and stores the images into the storage unit 108 in chronological order. These images can also be stored into a storage unit 302 of the information processing device 30 via the wire communication unit 106 described later.

As described above, the imaging optical system of the imaging unit 100 is fixed, and the imaging range A100 (see FIG. 2) is set in advance. This imaging range A100 is set in the world coordinate system, for example. Also, a positional relationship between the optical axis L100 (see FIG. 2) of the imaging optical system and the imaging element is specified. Thus, it is possible to associate position coordinates in the world coordinate system with images captured by the imaging unit 100. These pieces of information are stored in the storage unit 108 and the later-described storage unit 302 of the information processing device 30. Note that, in a case where the orientation of the optical axis L100 of the imaging optical system and the imaging range A100 are changed, the changed orientation of the optical axis L100 and the changed imaging range can be newly set in the world coordinate system.

The distance measurement unit 102 measures the distance to a terminal 20 by radio distance measurement through communication with the terminal 20. These pieces of distance information can also be stored into the storage unit 302 of the information processing device 30 via the wire communication unit 106 described later. Further, the distance measurement unit 102 can also measure a distance to another base station 10 through communication with the another base station 10.

Furthermore, the distance measurement range of the distance measurement unit 102 is fixed, for example, and the distance measurement range is set in advance. As described above, this distance measurement range is set in the world coordinate system, for example. This information is stored into the storage unit 108 and the later-described storage unit 302 of the information processing device 30. Note that details of the distance measurement unit 102 will be described later. Note that, in a case where the distance measurement range is changed, the changed distance measurement range can be newly set in the world coordinate system.

As described above, the communication unit 103 can communicate with the terminals 20 and the information processing device 30, and includes the wireless communication unit 104 and the wire communication unit 106. The wireless communication unit 104 can wirelessly communicate with the terminals 20 and the information processing device 30 via an antenna 104a. The wireless communication unit 104 and the antenna 104a are connected by a radio cable L104. Note that, in a case where another base station 10 is present, communication with the another base station 10 is also possible.

This wireless communication unit 104 can perform communication, using Bluetooth (registered trademark) Low Energy (BLE), for example. By BLE, it is possible to minimize the time necessary for operations requiring large electric power, such as connection establishment and data communication. Thus, power consumption can be reduced, and the wireless communication unit 104 can be made smaller in size. In this manner, the wireless communication unit 104 transmits and receives instructions, data, and the like to and from the outside of the base station 10. Note that, in the case of a base station 10 using only the wire communication unit 106, the wireless communication unit 104 may not be included. Alternatively, the wireless communication unit 104 may be shared with the distance-measuring radio waves to be used by the distance measurement unit 102, or may be formed separately from the distance-measuring radio waves to be used by the distance measurement unit 102.

The wire communication unit 106 can perform wire communication with the information processing device 30 and the like. This wire communication unit 106 transmits and receives instructions, data, and the like to and from the outside of the base station 10. Note that, in the case of a base station 10 using only the wireless communication unit 104, the wire communication unit 106 may not be included.

The storage unit 108 is formed with a hard disk drive (HDD), a solid-state drive (SSD), or the like, for example. The storage unit 108 can also store unique information, in addition to the above-described programs and image data. For example, the storage unit 108 stores, as unique information, the identification number of the base station 10, the location coordinates of the base station 10, wireless communication information, and the like. The wireless communication information is radio parameters or the like, and includes information about the length of the radio cable L104, for example. Further, as described above, the storage unit 108 can store the imaging range of the imaging unit 100 and the distance measurement range of the distance measurement unit 102 in the world coordinate system, for example.

The control unit 110 controls the entire base station 10. Further, the control unit 110 can also start driving of the distance measurement unit 102 and the imaging unit 100, in response to a reception signal from either a terminal 20 or the information processing device 30. That is, this control unit 110 can designate a distance measurement target of the distance measurement unit 102 among the terminals 20 and the other base stations 10, and designate the timing of distance measurement. The control unit 110 also performs control to transmit an image captured by the imaging unit 100 and information about a distance measured by the distance measurement unit 102 to the outside of the base station 10 through the wireless communication unit 104 or the wire communication unit 106. In this manner, the control unit 110 can process an instruction given from the outside via the wireless communication unit 104 or the wire communication unit 106, and control the entire operations of the base station 10. Note that an image according to the present embodiment is referred to as a video image in some cases.

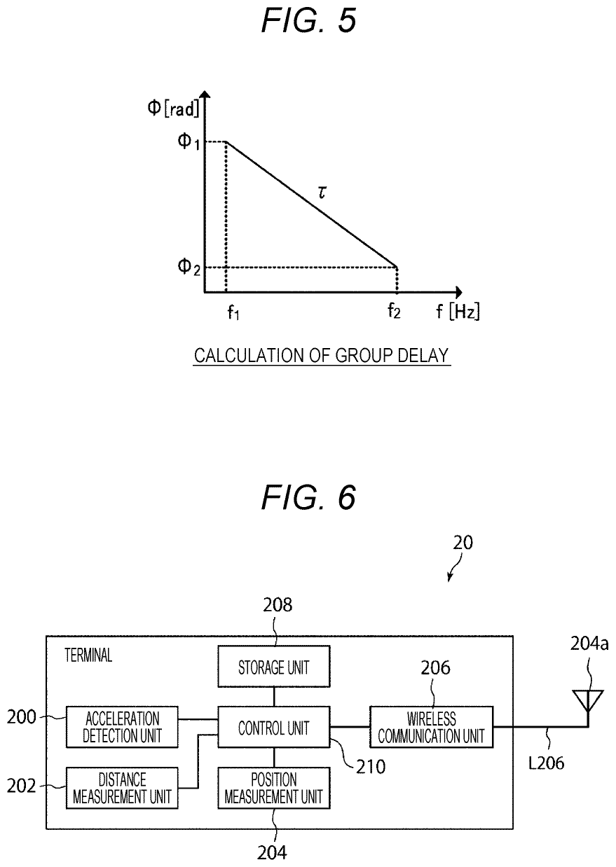

Here, an example of processing to be performed by the distance measurement unit 102 is described with reference to FIGS. 4 and 5. The distance measurement unit 102 can measure distance by a phase-based distance measurement method, for example. FIG. 4 is a diagram for explaining the principles of measuring distance by the phase-based distance measurement method. FIG. 5 is a diagram illustrating an example of a graph for calculating a group delay τ. In FIG. 5, the abscissa axis indicates frequency, and the ordinate axis indicates phase.

As illustrated in FIG. 4, by the phase-based distance measurement method, a wireless device (Initiator) and a wireless device (Reflector) emit a sine wave at the same frequency. Here, the wireless device (Initiator) is described as a wireless communication unit 206 (described later with reference to FIG. 5) of a terminal 20, and the wireless device (Reflector) is described as the wireless communication unit 104 of a base station 10, but these devices are not limited to this. For example, the wireless device (Initiator) may be the wireless communication unit 104 of a base station 10, and the wireless device (Reflector) may be the wireless communication unit 306 of a terminal 20.

By the phase-based distance measurement method, one terminal 20 (Initiator) first emits a sine wave at a frequency f [Hz]. A radio wave emitted from the terminal 20 travels toward a base station 10 (Reflector) that is the other wireless device at a distance D [m]. The base station 10 (Reflector) receives the radio wave emitted from the terminal 20 (Initiator), and receives a sine wave having a phase rotated in accordance with the distance D [m] at that time. Assuming that the phase of the sine wave at the time of transmission from the terminal 20 (Initiator) is 0 [rad], the sine wave having reached the base station 10 (Reflector) at the distance D [m] is received as a sine wave having a phase relatively rotated by Φ=−2πfD/c [rad] with respect to the phase emitted by the terminal 20 (Initiator). Here, c represents the speed of light, and f represents the frequency of the sine wave.

When the emission of the radio wave from the terminal 20 (Initiator) to the base station 10 (Reflector) comes to an end, the base station 10 (Reflector) next emits a radio wave to the terminal 20 (Initiator). At this point of time, the base station 10 (Reflector) emits a sine wave rotated beforehand by Φ [rad]. Therefore, the phase of the sine wave to be received by the terminal 20 (Initiator) is a phase rotated by the amount equivalent to the distance D [m] with respect to the phase Φ [rad] emitted by the base station 10 (Reflector), which means that the terminal 20 (Initiator) is to receive a sine wave having a phase rotated by 2Φ [rad].

At this point of time, it is already known that a sine wave having the phase of 0 [rad] has been first emitted from the terminal 20 (Initiator). Accordingly, it is clear that the phase rotates 2Φ [rad] when radio waves are reciprocated between the terminal 20 (Initiator) and the base station 10 (Reflector). Thus, on the side of the terminal 20 (Initiator), it becomes possible to calculate the amount of one-way phase rotation as Φ by halving the amount of the observed phase rotation of the sine wave from the base station 10 (Reflector).

The distance measurement unit 102 can draw the graph shown in FIG. 5, by reciprocating radio waves between the terminal 20 (Initiator) and the base station 10 (Reflector) while changing the frequency f [Hz]. In an environment where only direct waves are present, the graph of measurement results shows a straight line. To simplify mathematical expressions, the distance measurement unit 102 according to the present embodiment calculates the gradient of the straight line, which is the group delay τ, according to Expression (1) using phases Φ₂ and Φ₁ at two frequencies f₂ and f₁.

[Math. 1] Expression (1)

[Math. 2] Expression (2)

The distance measurement unit 102 then generates the distance D [m], according to Expression (2) obtained by substituting Φ=−2πfD/c into Expression (1). That is, the distance measurement unit 102 becomes able to calculate the distance between the terminal 20 (Initiator) and the base station 10 (Reflector) by obtaining the group delay τ from the phase measured while changing the frequency between the terminal 20 (Initiator) and the base station 10 (Reflector). Note that, for ease of explanation, the distance measurement unit 102 according to the present embodiment calculates the group delay τ as the gradient of the straight line connecting two points on the graph. However, the group delay τ may be calculated not by this method.

Further, the distance measurement unit 102 can subtract the length of the radio cable L104 and the length of a radio cable L206 of the terminal 20 from D in Expression (2). Thus, the total length of the length of the radio cable L104 and the length of the radio cable L206 is prevented from becoming an error. The length of the radio cable L206 can be acquired beforehand from the terminal 20 through wireless communication.

Further, an indirect wave is reflected by a wall, the floor, or the like in the room when irradiated. Therefore, its phase becomes larger than the phase of a direct wave. For example, in a case where a plurality of 2Φ [rad] is measured between the terminal 20 (Initiator) and the base station 10 (Reflector), it is possible to select the smallest 2Φ [rad]. As a result, it becomes possible to generate the group delay τ of only a direct wave. As described above, in a case where the phase-based distance measurement method is used, the distance between the terminal 20 (Initiator) and the base station 10 (Reflector) can be measured with higher accuracy even when an indirect wave occurs.

As can be seen from the above, by using the phase-based distance measurement method, it is possible to reduce the decrease in distance measurement accuracy even in a space where an indirect wave is generated like a space in a store. Note that the distance measurement unit 102 according to the present embodiment uses the phase-based distance measurement method, but is not limited to this. For example, distance may be measured by a distance measurement method using ultra wide band (UWB) wireless communication.

FIG. 6 is a block diagram illustrating an example configuration of a terminal 20. As illustrated in FIG. 6, the terminal 20 includes an acceleration detection unit 200, a distance measurement unit 202, a wireless communication unit 206, a storage unit 208, and a control unit 210. This terminal 20 includes a central processing unit (CPU), for example, and forms the respective components by executing various programs stored in the storage unit 208.

The acceleration detection unit 200 includes an acceleration sensor, and outputs a movement signal to the control unit 210 when the terminal 20 moves. Note that the acceleration detection unit 200 according to the present embodiment includes the acceleration detection unit 200, but is not limited to this. For example, the acceleration detection unit 200 may not be included in the configuration.

The distance measurement unit 202 has a configuration similar to the distance measurement unit 102 of a base station 10. That is, the distance measurement unit 202 measures the distance to a base station 10 through communication with the base station 10, using the phase-based distance measurement method, for example. Note that, in a case where a movement signal is output from the acceleration detection unit 200, for example, the distance measurement unit 202 can measure the distance to a base station 10 through communication with the base station 10 at predetermined time intervals.

The position measurement unit 204 measures the position of a terminal 20 with a global navigation satellite system (GNSS), for example. Specifically, in a region where measurement with the global positioning satellite system can be performed, the position measurement unit 204 transmits a global positioning signal indicating a position to the information processing device 30 via the wireless communication unit 206, under the control of the control unit 210. Note that the terminal 20 according to the present embodiment includes the position measurement unit 204, but is not limited to this. For example, the position measurement unit 204 may not be included in the configuration.

This wireless communication unit 206 can perform communication, using Bluetooth (registered trademark) Low Energy (BLE), for example. This wireless communication unit 206 transmits and receives instructions and the like to and from the outside of the terminal 20. Note that the wireless communication unit 206 may be shared with the distance-measuring radio waves to be used by the distance measurement unit 202, or may be formed separately from the distance-measuring radio waves to be used by the distance measurement unit 202.

The storage unit 208 is formed with a hard disk drive (HDD), a solid-state drive (SSD), or the like, for example. In addition to the above-mentioned various programs, the storage unit 208 stores unique information that is the identification number of the terminal 20, wireless communication information about the terminal 20, and the like, for example. The wireless communication information is radio parameters or the like, and includes information about the length of the radio cable L206, for example.

The control unit 210 controls the entire terminal 20. Further, the control unit 210 can also start driving of the distance measurement unit 202 and the position measurement unit 204, in response to a reception signal from either a terminal 20 or the information processing device 30. Specifically, this control unit 210 controls the position measurement unit 204 in accordance with a control instruction received via the wireless communication unit 206 or a situation such as terminal movement detected by the acceleration detection unit 200, and performs control to measure its own position. Furthermore, the control unit 210 can perform control to transmit a measured distance and position information to a base station 10 and the like via the wireless communication unit 206.

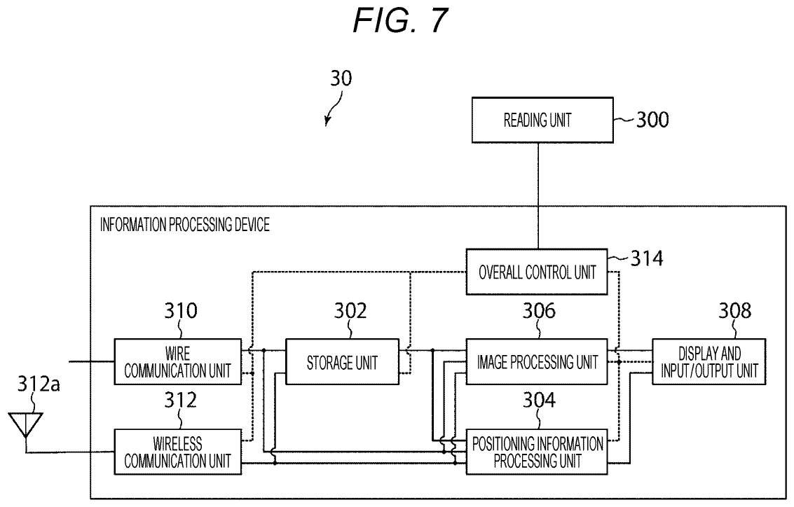

FIG. 7 is a block diagram illustrating an example configuration of the information processing device 30. As illustrated in FIG. 7, the information processing device 30 includes a reading unit 300, the storage unit 302, a positioning information processing unit 304, an image processing unit 306, a display and input/output unit 308, a wire communication unit 310, a wireless communication unit 312, and an overall control unit 314. This information processing device 30 is a computer device, for example, includes a central processing unit (CPU), and forms the respective components by executing various programs stored in the storage unit 302. Alternatively, the information processing device 30 can be formed with a portable device such as a smartphone. Furthermore, a plurality of information processing devices 30 can share the reading unit 300, the storage unit 302, the positioning information processing unit 304, the image processing unit 306, the display and input/output unit 308, the wire communication unit 310, the wireless communication unit 312, and the overall control unit 314, to perform cloud processing. Note that the overall control unit 314 according to the present embodiment corresponds to the first control unit.

Further, in a case where the information processing system 1 includes a plurality of information processing devices 30, an information processing device 30 can include some components among the reading unit 300, the storage unit 302, the positioning information processing unit 304, the image processing unit 306, the display and input/output unit 308, the wire communication unit 310, the wireless communication unit 312, and the overall control unit 314. For example, a surveillance staff member patrolling in the store carries a portable device such as a smartphone. In this case, the portable information processing device 30 can include the storage unit 302, the display and input/output unit 308, the wireless communication unit 312, and the overall control unit 314.

The reading unit 300 can read the identification numbers of the terminals 20, such as IDs, for example, and the identification numbers of articles. The identification numbers of articles are associated with information such as the types of the articles. The reading unit 300 is a barcode reader, for example, and the identification numbers of the terminals 20 and the identification numbers of the articles are attached as barcodes to the terminals 20 and the articles. The reading unit 300 associates the read identification numbers of the terminals 20 with the read identification numbers of the articles, and stores the identification numbers into the storage unit 302. Further, in a case where the charge for an article having a terminal 20 fixed thereto is paid, the reading unit 300 reads the identification number of the article, associates the identification number with information indicating that the article has been paid for, and stores the identification number and the information into the storage unit 302. Furthermore, when the information indicating that payment has been made is associated with the identification number of the article, the identification number of the terminal 20 may be erased from the storage unit 302. For example, when the identification number of the terminal 20 is erased, the terminal 20 can be associated with a new article. Note that, in a case where the charge for an article having a terminal 20 fixed thereto is paid, a store clerk removes and collects the terminal 20 from the article.

The storage unit 302 is formed with a hard disk drive (HDD), a solid-state drive (SSD), or the like, for example. The storage unit 302 can store various kinds of information transmitted from the base stations 10 and the terminals 20.

This storage unit 302 associates the identification numbers of a plurality of base stations 10, such as IDs, for example, with coordinates in the world coordinate system, and stores the identification numbers associated with the coordinates. Also, the storage unit 302 stores map information about the region to be monitored. This map information is associated with world coordinates. Furthermore, the identification numbers of the terminals 20 are associated with the identification numbers of the articles, and are stored, as described above.

Further, as described above, the imaging direction and the imaging range of each base station 10 are set in advance. As a result, the storage unit 302 can also store the imaging ranges and information regarding the imaging optical systems of the plurality of base stations 10, and the distance measurement ranges, which are associated with world coordinates. Note that the storage unit 302 according to the present embodiment are referred to as the information accumulation unit in some cases.

The positioning information processing unit 304 generates the coordinates of the terminals 20 in the world coordinate system in accordance with the principles of triangulation, for example, using the identification numbers of the terminals 20 and distance information transmitted from the plurality of base stations 10. The positioning information processing unit 304 associates the coordinates of the terminals 20 in the world coordinate system with time, for example, and stores the coordinates into the storage unit 302 in chronological order.

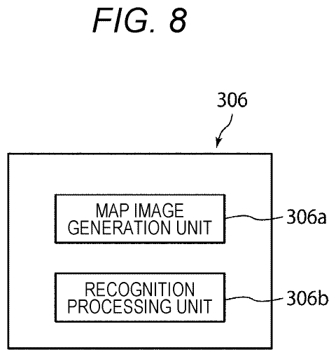

The image processing unit 306 can perform various kinds of information processing, under the control of the overall control unit 314. FIG. 8 is a block diagram illustrating an example configuration of the image processing unit 306. As illustrated in FIG. 8, the image processing unit 306 includes a map image generation unit 306a and a recognition processing unit 306b.

The map image generation unit 306a can generate a trajectory image in which the positions of the terminals 20 stored in chronological order are superimposed and displayed as a trajectory on the map information stored in the storage unit 302. Under the control of the overall control unit 314, the map image generation unit 306a generates a trajectory image in a case where a target enters the event occurrence region A100, for example. Note that, in a case where the charge for an article to which a terminal 20 is attached is paid, setting can be performed so that a series of processes related to an alarming process are not performed when the terminal 20 enters the event occurrence region A100.

The recognition processing unit 306b includes a plurality of recognition processing units corresponding to the identification numbers of the articles. For example, the recognition processing unit 306b includes a plurality of recognition processing units that have learned the shapes for the respective categories to which the identification numbers of the articles belong. As a result, when information about the identification number of an article is supplied, the overall control unit 314 recognizes the region corresponding to the identification number of the article from images captured by a plurality of base stations 10, using a recognition process corresponding to the identification number of the article. For example, in a case where the identification number of the article corresponds to a quadrangle, the recognition processing unit 306b recognizes a quadrangular region, and superimposes a mark on the images. For example, under the control of the overall control unit 314, the recognition processing unit 306b starts a recognition process on the captured images stored in the storage unit 302 in a case where the target enters the event occurrence region A100.

Also, the recognition processing unit 306b can recognize an article to which a terminal 20 is attached from a captured image, by referring to the coordinates of the terminal 20 in the world coordinate system, the coordinates having been generated by the positioning information processing unit 304. Accordingly, the recognition processing unit 306b can perform a process of recognizing articles mainly from coordinate information, and increase recognition accuracy. Further, the recognition processing unit 306b can mark the coordinates of a terminal 20 in the world coordinate system in a captured image.

Referring back to FIG. 7, the display and input/output unit 308 includes a display unit and an input device as illustrated in the drawing. The display unit is a monitor, for example, and the input device is formed with a keyboard, a mouse, and the like. The display unit of the display and input/output unit 308 can display a trajectory image or the like in which the position of a terminal 20 is superimposed and displayed as a trajectory. Also, the display unit can display a captured image in which the region of an article having a terminal 20 attached thereto as recognized by the recognition processing unit 306b is marked.

In this case, the coordinates of the terminal 20 secured to the article in the world coordinate system are measured. Accordingly, the image processing unit 306 can read the images including the position in the space corresponding to the position coordinates of the terminal 20 in the world coordinate system in the imaging range from the storage unit 302, arrange the trajectory of the article and the images obtained by imaging the article in chronological order, and display the trajectory and the images on the display unit under the control of the overall control unit 314. Further, the recognition processing unit 306b can also perform a recognition process on the images including the coordinate position of the terminal 20 secured to the article in the world coordinate system in the imaging range, and mark the coordinates in the captured images. In this case, the coordinates of the terminal 20 secured to the article in the world coordinate system are measured, and thus, the image processing unit 306 can mark the coordinates of the terminal 20 in the world coordinate system in the captured images.

As a result, in a case where the terminal 20 enters the event occurrence region A100, a store clerk or the like can arrange the trajectory of the article and the images in which the article is marked, and check the trajectory and the images in chronological order. As described above, the store clerk or the like can easily observe the movement state of the article from the movement trajectory and the captured images, without performing any operation of searching for images.

The wire communication unit 310 can perform wire communication with a base station 10 or the like. This wire communication unit 310 can perform transmission of a control instruction to a base station 10 or the like, data reception, and the like. The wireless communication unit 312 can perform wireless communication via an antenna 312a, using Bluetooth (registered trademark) Low Energy (BLE), for example. This wireless communication unit 312 can perform transmission of a control instruction to a base station 10 or the like, data reception, and the like. Although an example configuration according to the present embodiment has been described above, an example of control of the information processing system 1 will be described below.

### Movement of the Terminal 20A

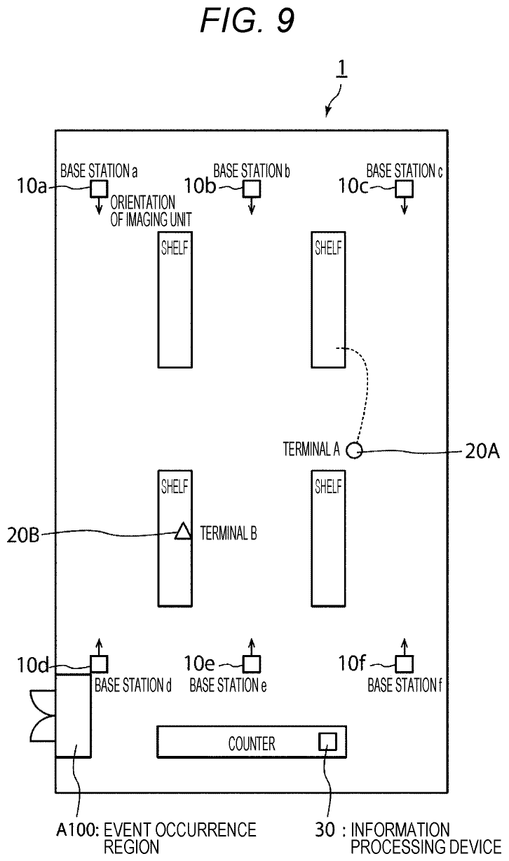

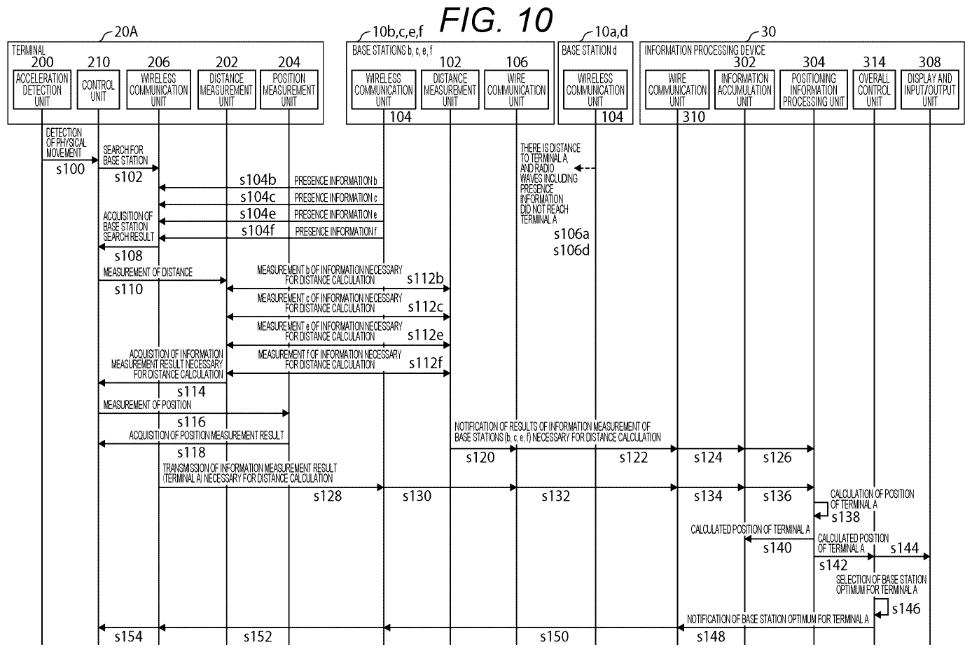

FIG. 9 is a plan view illustrating a case where the terminal 20A has moved. Further, FIG. 10 is a sequence diagram illustrating an operation of each component in the system in a case where the terminal 20A has moved.

As illustrated in FIGS. 9 and 10, in a case where the terminal 20A is taken out from the shelf, the acceleration sensor of the acceleration detection unit 200 in the terminal 20A detects the physical movement, and outputs a movement signal to the control unit 210 (step S100). Sensing the movement signal, the control unit 210 instructs the wireless communication unit 206 to search for a base station 10, and searches the neighboring base stations 10a to f for an available one (step S102).

In the situation in FIG. 9, it is possible to receive presence information signals of the base stations 10b, c, e, and f. On the other hand, presence information signals from the base stations 10a and d have not reached the terminal due to long distances or the like from the terminal (steps S106a and d), the control unit 210 of the terminal 20A acquires the base stations 10b, c, e, and f capable of wireless communication as a search result (step S108). Subsequently, after ending the search for the base stations 10b, c, e, and f, the terminal 20A measures distances to the respective base stations 10b, c, e, and f, from which the presence information signals have been successfully received (step S110).

Next, between the distance measurement unit 202 of the terminal 20A and the distance measurement units 102 of the base stations 10b, c, e, and f, sinusoidal communication necessary for calculating the group delay τ from the phase measured while changing the frequency of radio waves is repeated (steps S112b, c, e, and f). Subsequently, the distance measurement unit 202 of the terminal 20A calculates the group delay τ from the information obtained through communication with the base stations 10b, c, e, and f, calculates the distances to the base stations 10b, c, e, and f, and, when having finished the calculation process, outputs an end signal to the control unit 210 (step S114).

Further, when sensing the movement signal, the control unit 210 causes the distance measurement unit 202 to perform position measurement (step S116). If the global positioning satellite system is available, the distance measurement unit 202 communicates a position measurement result to the control unit 210 (step S118).

Meanwhile, the distance measurement unit 102 of each of the base stations 10b, c, e, and f stores information such as its own position coordinates and antenna parameters into the storage unit (information accumulation unit) 302 of the information processing device via the wire communication unit 106 and the wire communication unit 310 of the information processing device, and transmits the information to the positioning information processing unit 304 (steps S120 to S126). Subsequently, via the wireless communication unit 206, the terminal 20A stores various position measurement results into the storage unit (information accumulation unit) 302 of the information processing device via the wireless communication unit 104 and the wire communication unit 106 of each of the base stations 10b, c, e, and f, and the wire communication unit 310 of the information processing device, and communicates the position measurement results to the positioning information processing unit 304 (steps S128 to S136).

Next, the positioning information processing unit 304 calculates the world coordinates of the terminal 20A in accordance with the principles of triangulation, using various kinds of information (step S138). The positioning information processing unit 304 causes the storage unit (information accumulation unit) 302 to store the world coordinates of the terminal 20A associated with the measurement time, and causes the display and output unit 308 to present the world coordinates via the overall control unit 314 (steps S140 to S144). The overall control unit 314 then uses information about the measurement ranges of the base stations 10b, c, e, and f stored in the storage unit (information accumulation unit) 302, to select the base station 10 to be mainly used for position measurement of the terminal 20A from among the base stations 10b, c, e, and f (step S146).

The base station selected for use in position measurement of the terminal 20A, and the terminal 20A are notified of the selection via the wire communication unit 310 of the information processing device 30, the wire communication unit 106 and the wireless communication unit 104 of the base station 10, and the wireless communication unit 206 of the terminal 20A (steps S148 to S154). The terminal 20A performs the next and subsequent distance measuring operations with the selected base station 10, on the basis of base station information provided from the overall control unit 314 of the information processing device 30.

### End of the Monitoring of the Terminal 20A

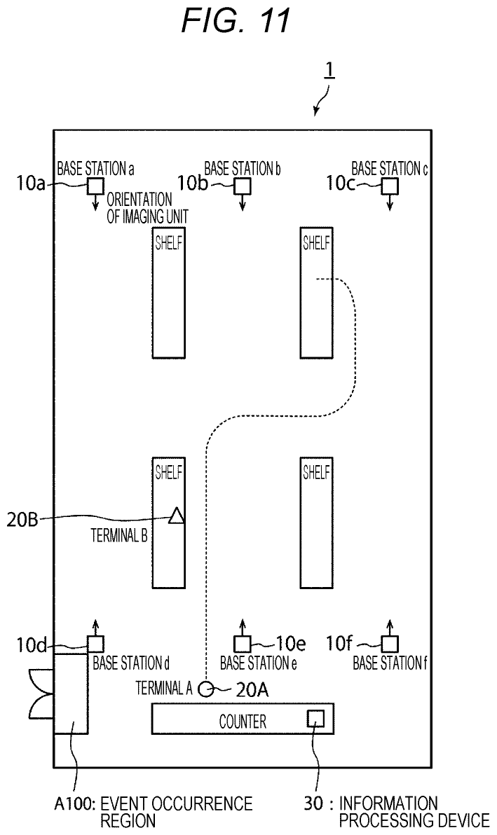

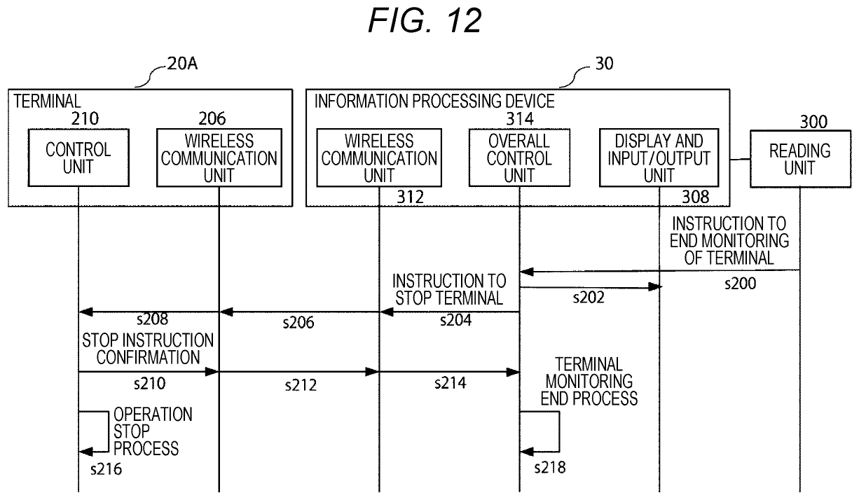

FIG. 11 is a plan view illustrating a case where the terminal 20A has moved, and the monitoring is ended at the counter. Further, FIG. 12 is a sequence diagram at the time of the monitoring end process.

In a case where the terminal 20A is brought onto the counter, and there is no problem in taking it away, a user (a store clerk) at the counter reads the barcodes of the article and the terminal 20A with the reading unit 300 of the information processing device 30, and notifies the overall control unit 314 of a monitoring end signal regarding the terminal 20A (step S200). The overall control unit 314 causes the display and input unit 308 to display information regarding the article and the terminal 20A (step S202). At this point of time, the user (store clerk) can remove the terminal 20A from the article.

Next, the overall control unit 314 transmits a stop instruction signal to the control unit 210 of the terminal 20A via the wireless communication unit 312 and the wireless communication unit 206 of the terminal 20A (steps S204 to S 208). Subsequently, the control unit 210 of the terminal 20A transmits a stop confirmation signal to the overall control unit 314 via the wireless communication unit 206 of the terminal 20A and the wireless communication unit 312 of the information processing device 30 (steps S210 to S214).

Next, the terminal 20A transmits a stop instruction confirmation signal to the overall control unit 314 of the information processing device 30, and then stops its own operation (step S216). Receiving the stop time confirmation signal of the terminal 20A, the overall control unit 314 of the information processing device 30 ends the process of monitoring the terminal 20A, which the overall control unit 314 has been performing.

### Case Where a Terminal Enters the Event Occurrence Region, Without Any Monitoring End Process Performed

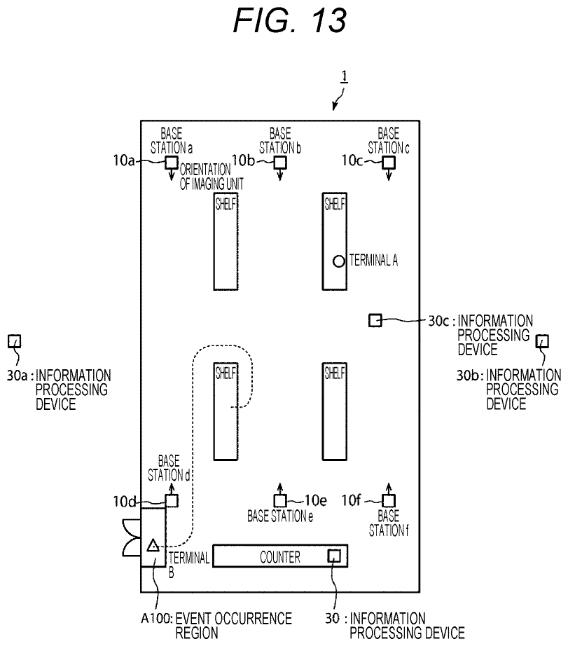

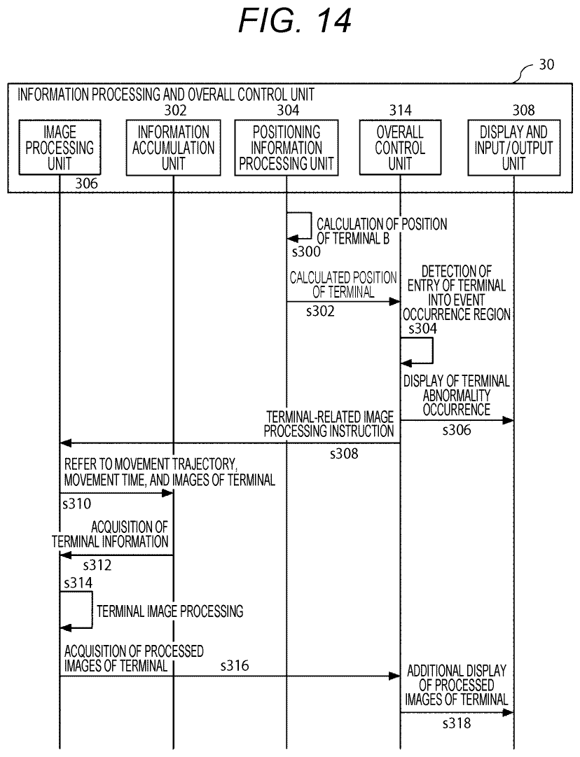

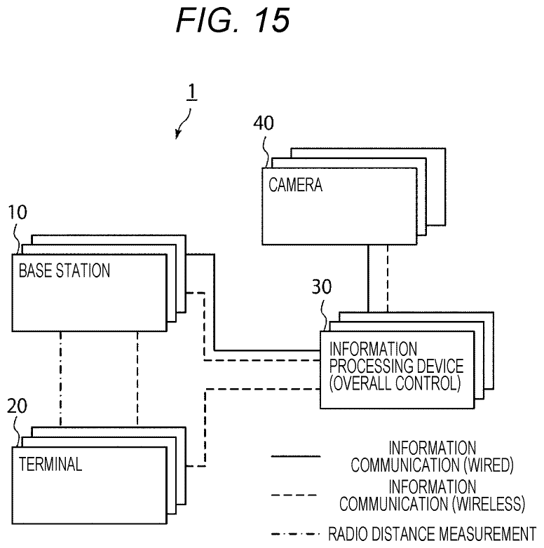

FIG. 13 is a plan view illustrating a case where the terminal 20B has entered the event occurrence region without having been subjected to a monitoring end process at the counter. In FIG. 13, a plurality of information processing devices 30 and 30a to c are provided. The information processing devices 30a to c are portable smartphones, and are carried by security guards, for example. Further, FIG. 14 is a sequence diagram illustrating a case of entering the event occurrence region.

The overall control unit 314 of the information processing device 30 calculates position information about the terminal 20B from the positioning information processing unit 304 (step S300), and notifies the overall control unit 314 of the position information (step S302). Next, the overall control unit 314 determines that the terminal 20B is in the event occurrence region A100, on the basis of the calculated position information (step S304).

Having determined that the terminal 20B is in the event occurrence region A100, the overall control unit 314 presents the occurrence of an abnormality in the terminal 20B as alarm information to the user via the display and input/output unit 308. Also, the overall control unit 314 presents the occurrence of the abnormality in the terminal 20B as alarm information to the security guards via the display and input/output units 308 of the other information processing devices 30a to c (step S306).

At the same time, the overall control unit 314 also causes the image processing unit 306 to start image processing related to the terminal 20B (step S308). Receiving an image processing instruction related to the terminal 20B, the image processing unit 306 acquires information about the movement trajectory and the movement time of the terminal 20B from the storage unit (information accumulation unit) 302 (steps S310 and S312). For example, the image processing unit 306 acquires, from the storage unit 302, images showing the movement start position at the movement start time of the terminal 20B.

In the case illustrated in FIG. 13, the image processing unit 306 acquires images captured at the movement start time by the base stations 10b and 10e, for which the movement start position of the terminal 20B is within the imaging ranges, on the basis of information about the imaging ranges of the base stations 10a to f. Also, the image processing unit 306 acquires images captured at the movement start time by the base stations 10a and 10d capable of imaging from the opposite sides, in accordance with the movement trajectory and the movement time of the terminal 20B. An image at the movement start time is normally captured before an article is put into a tote bag or the like. Accordingly, there is a high possibility that the object to which the terminal 20B is attached, and the person moving the object can be recognized from the images captured at the movement start time.

The recognition processing unit 306b of the image processing unit 306 performs a process of recognizing the object to which the terminal 20B is attached in the acquired images, using a recognition process compatible with the shape of the object to which the terminal 20B is attached (step S314). In a case where recognition has been successfully performed, a first mark is superimposed on the object in the images. In a case where recognition has not been successfully performed, a second mark different from the first mark is superimposed on the position corresponding to the movement start position in the images. The first mark and the second mark can have different colors, shapes, and the like. In this manner, the positioning information processing unit 304 of the information processing device 30 wirelessly measures the position of the terminal 20B. Accordingly, even in a case where a person or the like is an obstacle, and the object to which the terminal 20B is attached is not directly shown in the images captured by the imaging units 100 of the base stations 10, the position of the object to which the terminal 20B is attached can be recognized from the images.

The image processing unit 306 transmits the images subjected to the image processing, to the overall control unit 314 (step S316). The overall control unit 314 then presents the images processed by the image processing unit 306 as information regarding the terminal 20B to the user via the display and input/output unit 308. Also, images equivalent to those presented by the information processing device 30 are presented via the display and input/output units 308 of the other information processing devices 30a to c.

As described above, according to the present embodiment, the position of the terminal 20 attached to the article to be monitored is measured in chronological order and is stored into the storage unit 302 of the information processing device 30, and captured images in which chronological position information is associated with time information are stored into the storage unit 302. As a result, in a case where the article to be monitored is in the event occurrence region A100, it is possible to issue an alarm and present images showing the movement trajectory of the terminal 20 to the user in chronological order via the display and input/output unit 308. Thus, it is possible to more easily observe the images from the removal of the article to be monitored to the move to the event occurrence region A100.

Further, the recognition processing unit 306b of the image processing unit 306 performs a process of recognizing the object to which the terminal 20B is attached. In a case where recognition has been successfully performed, the first mark is superimposed on the object in the images. In a case where recognition has not been successfully performed, the second mark different from the first mark is superimposed on the position corresponding to the movement start positions in the images. As a result, in a case where the terminal 20 has entered the event occurrence region A100, a user (a store clerk) or the like can check the trajectory of the object to which the terminal 20B is attached, and the images that show the marked object and are arranged in chronological order. In this case, the time information is also linked between both images, and thus, it is possible to easily recognize the movement state of the object to which the terminal 20B is attached. Further, even in a case where the object to which the terminal 20B is attached is put into a tote bag or the like, it is possible to check the trajectory of the object to which the terminal 20B is attached, and the images that show the marked object and are arranged in chronological order. Thus, it is also easy to recognize the tote bag or the like into which the object to which the terminal 20B is attached has been put.

### Second Embodiment

An information processing system 1 according to a second embodiment differs from the information processing system 1 according to the first embodiment in further including a camera 40. In the description below, differences from the information processing system 1 according to the first embodiment will be described.

FIG. 15 is a diagram illustrating an example configuration of the information processing system 1 according to the second embodiment of the present technology. As illustrated in FIG. 15, the information processing system 1 further includes the camera 40. A plurality of cameras 40 may be included.

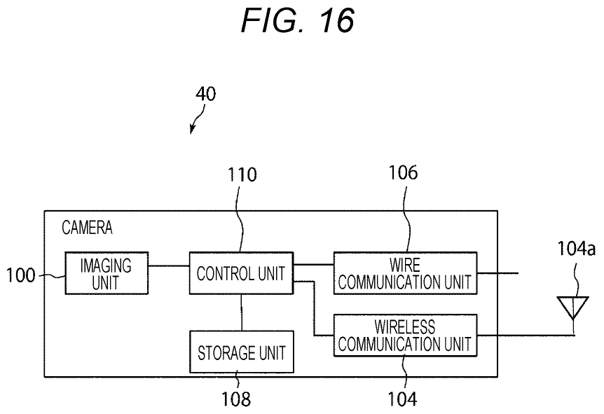

FIG. 16 is a block diagram illustrating an example configuration of the camera 40. The camera 40 has a configuration similar to a base station 10, except for the distance measurement unit 102. That is, the camera 40 includes an imaging unit 100, a wireless communication unit 104, a wire communication unit 106, a storage unit 108, and a control unit 110. This base station 10 includes a central processing unit (CPU), for example, and forms the respective components by executing various programs stored in the storage unit 108. The storage unit 108 of the camera 40 stores, as unique information, the identification number of the camera 40, the placement coordinates of the camera 20, information regarding the imaging optical system, wireless communication information, and the like.

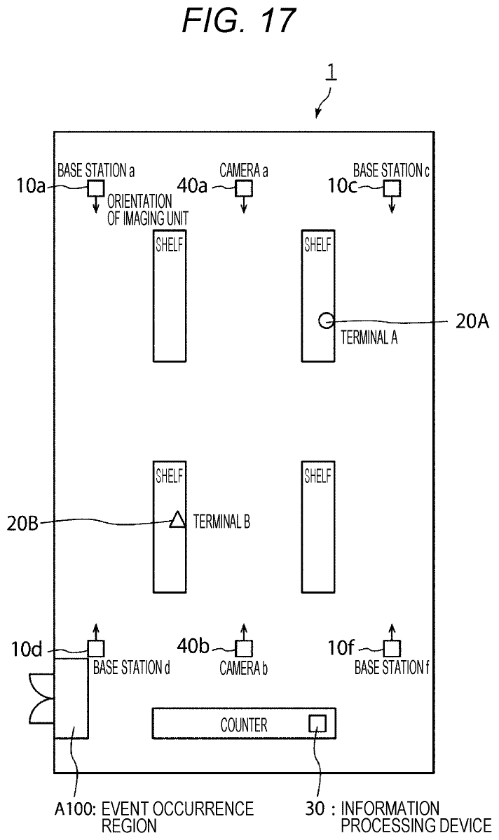

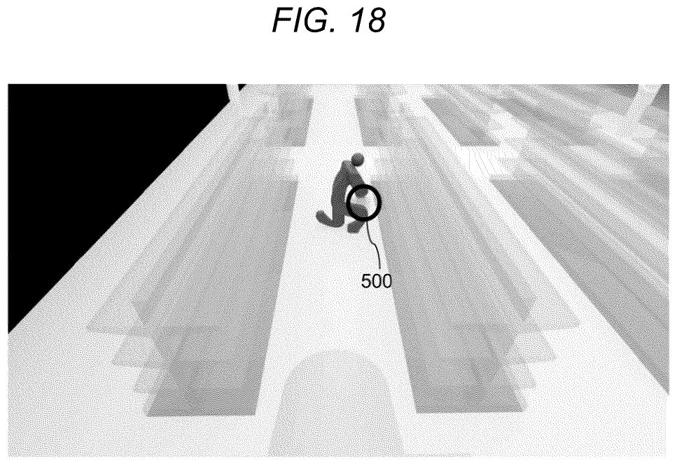

FIG. 17 is an example of a plan view of the inside of a store to be monitored. Articles are on shelves in the store. In FIG. 17, a plurality of base stations 10a, c, d, and f, a plurality of terminals 20A and B, an information processing device 30, and a plurality of cameras 40a and b are provided. For example, in a case where the entire area in the store can be covered by the radio wave irradiation ranges of the base stations 10a, c, d, and f, the cameras 40a and b can be provided, instead of the base stations 10, to cover the imaging ranges. The plurality of base stations 10a, c, d, and f and the cameras 40a and b are disposed so as to be able to capture images of the entire area in the store. Note that FIG. 18 is a view of a scene in which a person crouching in the screen of a camera is putting an article 500 into a bag.

As described above, in the information processing system 1 according to the present embodiment, in a case where the entire area in the store can be covered by the radio wave irradiation ranges of the base stations 10a, c, d, and f, the cameras 40a and b for covering the imaging ranges are provided in place of the base stations 10. Thus, it is possible to reduce the radio wave overlapping area while maintaining the imaging ranges in the store.

Note that the present technology may have the following configurations.

(1)

An information processing device including:
a positioning information processing unit that generates position coordinates in chronological order, on the basis of distance measured by radio distance measurement from a plurality of sets of coordinates to a terminal attached to an article; and
a first control unit that causes a display unit to display an image on the basis of time of the radio distance measurement, the image having an imaging range including a position in a space, the position corresponding to at least one set of the chronological position coordinates, the image corresponding to the time at which the position in the space has been measured by radio distance measurement.
   (2)

The information processing device according to (1), in which, when the position coordinates are located within a predetermined region, the first control unit causes the display unit to display the image.

(3)

The information processing device according to (2), in which the radio distance measurement is performed by a distance measurement method using phase characteristics of frequency through wireless communication between a plurality of base stations and the terminal.

(4)

The information processing device according to (2), in which, when the position coordinates are located within the predetermined region, the first control unit issues warning information.

(5)

The information processing device according to (1), in which the display unit displays the image captured at a point of time at which the terminal started moving.

(6)

The information processing device according to (1), further including
a storage unit,
in which the positioning information processing unit generates the position coordinates associated with the time of the radio distance measurement, and stores the position coordinates into the storage unit.
   (7)

The information processing device according to (6), further including
a map image generation unit that superimposes a chronological change in the position coordinates as trajectory information on a map image.
   (8)

The information processing device according to (7), in which the display unit displays, side by side, the map image on which the trajectory information is superimposed, and the image corresponding to the time of the radio distance measurement of the position coordinates included in the trajectory information.

(9)

The information processing device according to (6), further including a recognition processing unit that recognizes a region of the article from the image.

(10)

The information processing device according to (9), in which the recognition processing unit superimposes a first mark indicating the region in the image.

(11)

The information processing device according to (10), in which the recognition processing unit superimposes a second mark indicating a portion corresponding to the position coordinates in the image.

(12)

The information processing device according to (11), in which the first control unit causes the recognition processing unit to start a recognition process when the position coordinates are located within a predetermined region.

(13)

The information processing device according to (12), further including
a reading unit that reads first identification information about the article,
in which the recognition processing unit recognizes the region through a recognition process corresponding to the first identification information.
   (14)

The information processing device according to (13), in which the reading unit is capable of reading second identification information about the terminal, and stores the second identification information associated with the first identification information into the storage unit.

(15)

The information processing device according to (14), in which, when the first identification information or the second identification information is read, the first control unit stops generation of the position coordinates of the article, and stops operation of the terminal.

(16)

The information processing device according to (1), in which the first control unit selects a base station that measures distance to the terminal through wireless communication with the terminal on the basis of the position coordinates, selects an image captured from a plurality of sets of predetermined coordinates on the basis of the position coordinates, and causes the display unit to display the image.

(17)

An information processing method including:
a positioning information processing step of generating position coordinates in chronological order, on the basis of distance measured by radio distance measurement from a plurality of sets of coordinates to a terminal attached to an article; and
a first control step of causing a display unit to display an image on the basis of the time of the radio distance measurement, the image having an imaging range including a position in a space, the position corresponding to at least one set of the chronological position coordinates, the image corresponding to the time at which the position in the space has been measured by radio distance measurement.
   (18)

An information processing system including:
a plurality of base stations that is used to measure distance to a terminal attached to an article by a distance measurement method using phase characteristics of frequency through wireless communication with the terminal;
an imaging unit that is included in the base station or a camera, and captures an image of the terminal attached to the article while putting the terminal in an imaging range; and
an information processing device,
in which the information processing device includes
a positioning information processing unit that generates position coordinates in chronological order, on the basis of distance measured by radio distance measurement from coordinates of the plurality of base stations to the terminal, and
in the image captured by the imaging unit,
a first control unit that causes a display unit to display an image on the basis of the time of the radio distance measurement, the image having an imaging range including a position in a space, the position corresponding to at least one set of the chronological position coordinates, the image corresponding to the time at which the position in the space has been measured by radio distance measurement.
   (19)

An imaging device including:
a distance measurement unit that is used to generate position coordinates of a terminal attached to an article in chronological order, and performs radio distance measurement to measure distance to the terminal;
a wireless communication unit that wirelessly communicates with the terminal; and
an imaging unit that includes an imaging optical system having a specified imaging range and an imaging element, and captures an image with which the position coordinates can be associated in a captured image.
   (20)

A terminal that is attached to an article, the terminal including:
a distance measurement unit that is used to generate position coordinates of the terminal in chronological order, and performs radio distance measurement with a predetermined base station to measure distance to the terminal; and
a wireless communication unit that wirelessly communicates with the predetermined base station.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Information processing system
10, 10a to f Base station
20, 20A, 20B Terminal
30, 30a to c Information processing device
40, 40a, 40b Camera
100 Imaging unit
102 Distance measurement unit
103 Communication unit
104 Wireless communication unit
202 Distance measurement unit
302 Storage unit
306a Map image generation unit
306b Recognition processing unit
308 Display and output unit
500 Article

1. An information processing device comprising:
a positioning information processing unit that generates position coordinates in chronological order, on a basis of distance measured by radio distance measurement from a plurality of sets of coordinates to a terminal attached to an article; and
a first control unit that causes a display unit to display an image on a basis of time of the radio distance measurement, the image having an imaging range including a position in a space, the position corresponding to at least one set of the chronological position coordinates, the image corresponding to time at which the position in the space has been measured by radio distance measurement.

2. The information processing device according to claim 1, wherein, when the position coordinates are located within a predetermined region, the first control unit causes the display unit to display the image.

3. The information processing device according to claim 2, wherein the radio distance measurement is performed by a distance measurement method using phase characteristics of frequency through wireless communication between a plurality of base stations and the terminal.

4. The information processing device according to claim 2, wherein, when the position coordinates are located within the predetermined region, the first control unit issues warning information.

5. The information processing device according to claim 1, wherein the display unit displays the image captured at a point of time at which the terminal started moving.

6. The information processing device according to claim 1, further comprising
a storage unit,
wherein the positioning information processing unit generates the position coordinates associated with the time of the radio distance measurement, and stores the position coordinates into the storage unit.

7. The information processing device according to claim 6, further comprising
a map image generation unit that superimposes a chronological change in the position coordinates as trajectory information on a map image.

8. The information processing device according to claim 7, wherein the display unit displays, side by side, the map image on which the trajectory information is superimposed, and the image corresponding to the time of the radio distance measurement of the position coordinates included in the trajectory information.

9. The information processing device according to claim 6, further comprising a recognition processing unit that recognizes a region of the article from the image.

10. The information processing device according to claim 9, wherein the recognition processing unit superimposes a first mark indicating the region in the image.

11. The information processing device according to claim 10, wherein the recognition processing unit superimposes a second mark indicating a portion corresponding to the position coordinates in the image.

12. The information processing device according to claim 11, wherein the first control unit causes the recognition processing unit to start a recognition process when the position coordinates are located within a predetermined region.

13. The information processing device according to claim 12, further comprising
a reading unit that reads first identification information about the article,
wherein the recognition processing unit recognizes the region through a recognition process corresponding to the first identification information.

14. The information processing device according to claim 13, wherein the reading unit is capable of reading second identification information about the terminal, and stores the second identification information associated with the first identification information into the storage unit.

15. The information processing device according to claim 14, wherein, when the first identification information or the second identification information is read, the first control unit stops generation of the position coordinates of the article, and stops operation of the terminal.

16. The information processing device according to claim 1, wherein the first control unit selects a base station that measures distance to the terminal through wireless communication with the terminal on a basis of the position coordinates, selects an image captured from a plurality of sets of predetermined coordinates on a basis of the position coordinates, and causes the display unit to display the image.

17. An information processing method comprising:
a positioning information processing step of generating position coordinates in chronological order, on a basis of distance measured by radio distance measurement from a plurality of sets of coordinates to a terminal attached to an article; and
a first control step of causing a display unit to display an image on a basis of the chronological position coordinates and time of the radio distance measurement, the image having an imaging range including a position in a space, the position corresponding to at least one set of the chronological position coordinates, the image corresponding to time at which the position in the space has been measured by radio distance measurement.

18. An information processing system comprising:
a plurality of base stations that is used to measure distance to a terminal attached to an article by a distance measurement method using phase characteristics of frequency through wireless communication with the terminal;
an imaging unit that is included in the base stations or a camera, and captures an image of the terminal attached to the article while putting the terminal in an imaging range; and
an information processing device,
wherein the information processing device includes a positioning information processing unit that generates position coordinates in chronological order, on a basis of distance measured by radio distance measurement from coordinates of the plurality of base stations to the terminal, and
in the image captured by the imaging unit,
a first control unit that causes a display unit to display an image on a basis of the chronological position coordinates and time of the radio distance measurement, the image having an imaging range including a position in a space, the position corresponding to at least one set of the chronological position coordinates, the image corresponding to time at which the position in the space has been measured by radio distance measurement.

19. An imaging device comprising:
a distance measurement unit that is used to generate position coordinates of a terminal attached to an article in chronological order, and performs radio distance measurement to measure distance to the terminal;
a wireless communication unit that wirelessly communicates with the terminal; and
an imaging unit that includes an imaging optical system having a specified imaging range and an imaging element, and captures an image with which the position coordinates can be associated in a captured image.

20. A terminal that is attached to an article, the terminal comprising:
a distance measurement unit that is used to generate position coordinates of the terminal in chronological order, and performs radio distance measurement with a predetermined base station to measure distance to the terminal; and
a wireless communication unit that wirelessly communicates with the predetermined base station.
